(19) United States
(12) Patent Application Publication
(10) Pub. No.: US 2025/0244624 A1
(43) Pub. Date: Jul. 31, 2025

(54) DISPLAY DEVICE AND ARRAY SUBSTRATE

(71) Applicant: Japan Display Inc., Tokyo (JP)

(72) Inventors: Masateru MORIMOTO, Tokyo (JP); Teppei YAMADA, Tokyo (JP)

(21) Appl. No.: 19/036,124

(22) Filed: Jan. 24, 2025

(30) Foreign Application Priority Data
Jan. 31, 2024 (JP) 2024-013505

(51) Int. Cl. G02F 1/1362

(52) U.S. Cl. CPC G02F 1/136254; G02F 1/136286

(57) ABSTRACT

A display device includes an inspection unit that performs inspection of a display unit, the inspection unit including first wiring which has a first line extending in an X direction and a second line obliquely intersecting the first line, and second wiring which has third lines orthogonal to the first line in plan view. The second line has a connection portion that obliquely intersects and is connected to the first line, a first portion that is disposed side by side with the third lines from one end of the connection portion, and a second portion that is disposed side by side with the third lines from another end in an opposite direction to the first portion. The wide portions of the third lines are located at intersection portions where the third lines and the first line intersect each other in plan view.

### CROSS REFERENCES TO RELATED APPLICATIONS

The present application claims priority to Japanese Patent Application No. 2024-013505 filed on Jan. 31, 2024, the disclosure of which is incorporated herein by reference.

### BACKGROUND

The present invention relates to a display device and an array substrate.

Japanese Patent Application Laid-Open No. 2001-67020 discloses a matrix array substrate configured to prevent a short circuit between a signal-line upper layer wiring and a scanning line by providing, at an intersection portion of a signal line and the scanning line, a signal-line lower layer wiring having a sufficiently wide width to absorb variations in contour position of the signal-line upper layer wiring.

### SUMMARY

In a display device and an array substrate, it is desired to prevent disconnection from occurring.

A display device according to an embodiment includes: a display unit; and an inspection unit that performs display inspection of the display unit, the inspection unit including a first wiring which has a first line extending in a first direction and a second line obliquely intersecting the first line, and a second wiring which is provided at an upper layer above the first wiring and has third lines orthogonal to the first line extending in the first direction in plan view. The second line has a connection portion that obliquely intersects and is connected to the first line, a first portion that is disposed side by side with the third lines from one end of the connection portion, and a second portion that is disposed side by side with the third line from another end of the connection portion in an opposite direction to the first portion. The third lines have respective wide portions having a width which increases toward the connection portion. The wide portion is located at an intersection portion where the third lines and the first line intersect each other in plan view.

An array substrate according to an embodiment includes an inspection unit that performs display inspection, the inspection unit including a first wiring which has a first line extending in a first direction and a second line obliquely intersecting the first line, and a second wiring which is provided at an upper layer above the first wiring and has third lines orthogonal to the first line extending in the first direction in plan view. The second line has a connection portion that obliquely intersects the first line, a first portion that is disposed side by side with the third lines from one end of the connection portion, and a second portion that is disposed side by side with the third lines from another end of the connection portion in an opposite direction to the first portion. The third lines have respective wide portions having a width which increases toward the connection portion. The wide portion is located at an intersection portion where the third lines and the first line intersect each other in plan view.

### BRIEF DESCRIPTION OF THE DRAWINGS

FIG. 1 is a plan view illustrating a schematic configuration example of a liquid crystal display device.

FIG. 2 is a diagram illustrating a part of a cross section along A-A in FIG. 1.

FIG. 3 is an enlarged plan view of the vicinity of a terminal region.

FIG. 4 is a diagram illustrating a cross section along B-B in FIG. 3.

FIG. 5 is a diagram illustrating an equivalent circuit corresponding to FIG. 3.

FIG. 6 is a schematic plan view illustrating a part of a structure example of an inspection circuit.

FIG. 7 is a diagram illustrating a cross section along C-C in FIG. 6.

FIG. 8 is a diagram for describing a structure around a connection portion of a first wiring and a second wiring.

FIG. 9 is a schematic plan view illustrating a structure example of an inspection circuit according to a comparative example.

FIG. 10 is a diagram illustrating a cross section along D-D in FIG. 9.

FIG. 11 is a schematic plan view illustrating a modification example of the inspection circuit.

FIG. 12 is a diagram illustrating a modification example of the first wiring.

### DETAILED DESCRIPTION

Hereinafter, embodiments will be described with reference to the drawings.

Note that the present disclosure is merely an example, and an aspect that can be easily conceived by those skilled in the art by performing appropriate modification while maintaining the gist of the present disclosure is naturally included in the scope of the present disclosure.

In addition, the drawings, in which a width, a thickness, a shape, and the like of each portion may be schematically illustrated as compared with an actual aspect in order to make the description clearer, are merely examples, and do not limit the interpretation of the present disclosure. In the present specification and all the drawings, the same reference numerals are assigned to the same elements as those illustrated in the previous drawings, and the detailed description thereof may be omitted as appropriate.

In the embodiment, a liquid crystal display device including a liquid crystal display element is disclosed as an example of am, display device. However, the embodiment does not preclude the technical idea disclosed in the embodiment from being applied to a display device including another type of display element represented by, for example, an organic electroluminescence display element, a micro LED, a mini LED, or the like. In addition, the technical idea disclosed in the embodiment can also be applied to an array substrate or an electronic device which includes a sensor element represented by a capacitive sensor, an optical sensor, or the like.

### Overall Configuration of Liquid Crystal Display Device

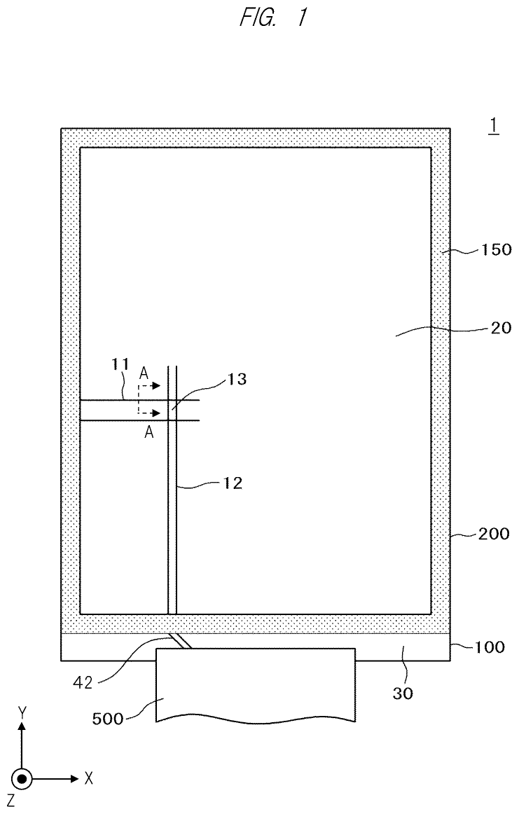

FIG. 1 is a plan view illustrating a schematic configuration example of a liquid crystal display device 1.

As illustrated in FIG. 1, an X direction, a Y direction, and a Z direction are defined. The X direction, the Y direction, and the Z direction are directions orthogonal to each other, but may intersect at an angle other than the perpendicular angle. A view of the liquid crystal display device 1 and components thereof in parallel with the Z direction is referred to as a “plan view”. In addition, a direction represented by an arrow in the Z direction may be referred to as “upward”, and the opposite direction thereof may be referred to as “downward”.

As illustrated in FIG. 1, the liquid crystal display device 1 includes a TFT substrate 100 (an array substrate, a second substrate) and a facing substrate 200 (a first substrate). In the liquid crystal display device 1, the TFT substrate 100 and the facing substrate 200 are provided to overlap each other. In plan view, the facing substrate 200 has a first rectangular shape, and TFT substrate 100 has a second rectangular shape. The TFT substrate 100 and the facing substrate 200 have long sides in the Y direction and short sides in the X direction. A length of the TFT substrate 100 in the Y direction is longer than a length of the facing substrate 200. In other words, in plan view, three sides of the four sides of the rectangular shape of the TFT substrate 100 are aligned with the corresponding sides of the facing substrate 200, while one side thereof projects beyond the corresponding side of the facing substrate 200. The TFT substrate 100 and the facing substrate 200 are bonded to each other by a sealing material 150 provided on a perimeter portion of the facing substrate 200, and liquid crystal is sealed therein. A display region 20 is formed in a region which is surrounded by the sealing material 150 and in which the liquid crystal is sealed. In the display region 20, scanning lines 11 extend in the X direction as a horizontal direction and are arranged in the Y direction. In addition, in the display region 20, video signal lines 12 extend in the Y direction and are arranged in the X direction. A region surrounded by the scanning lines 11 and the video signal lines 12 forms a pixel 13.

A terminal region 30 is formed in a portion in which the TFT substrate 100 projects beyond the facing substrate 200. A flexible wiring substrate 500 is connected to the terminal region 30. A power supply, a scanning signal, a video signal, a clock signal, or the like is supplied from the flexible wiring substrate 500 to the display region 20. The display region 20 and the flexible wiring substrate 500 are connected by a second wiring 42 to be described in detail below. As described above, since the flexible wiring substrate 500 is connected to the terminal region 30, an area of the terminal region 30 can be reduced, and a frame thereof can be reduced. A driver IC (not illustrated) is mounted on the flexible wiring substrate 500.

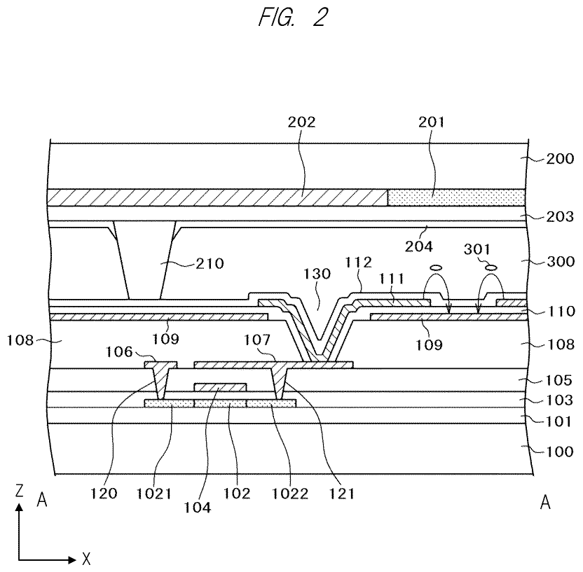

FIG. 2 is a diagram illustrating a part of a cross section along A-A in FIG. 1.

The display region 20 and the terminal region 30 are simultaneously formed. Therefore, cross sections of the display region 20 and the terminal region 30 have similar configurations. An example of a basic layer configuration of the display region 20 will be described with reference to FIG. 2. In addition, the display region 20 and the terminal region 30 are formed by the same process. The cross section of the display region 20 illustrated in FIG. 2 is a case where the liquid crystal display device 1 is an in plane switching (IPS) system.

In FIG. 2, the TFT substrate 100 is generally formed of glass, but in a case where a flexible display device is desired, the TFT substrate 100 is formed of a resin such as polyimide. On the TFT substrate 100, an underlying film 101 is formed of a laminated film of silicon oxide (SiO) and silicon nitride (SiN). A function of the underlying film 101 is to prevent impurities from the TFT substrate 100 from contaminating a semiconductor layer 102.

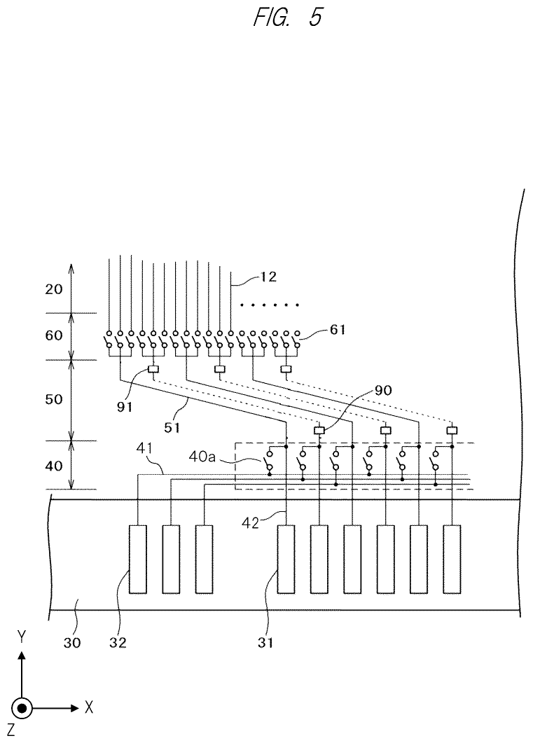

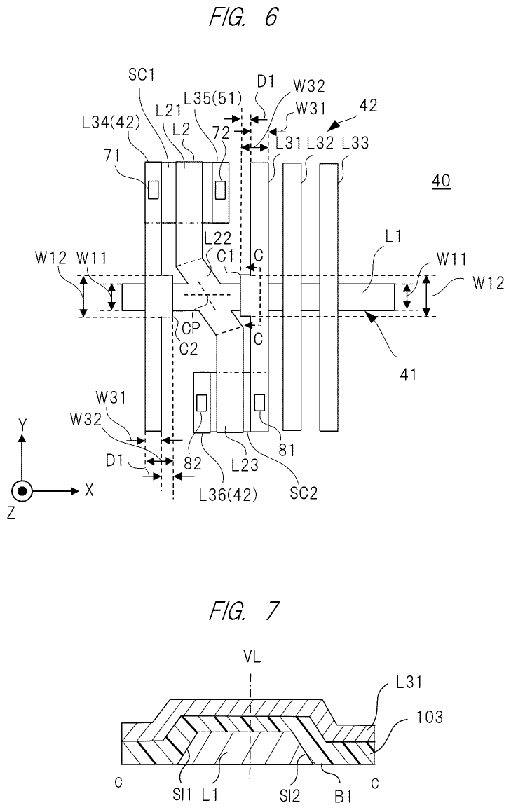

The semiconductor layer 102 is formed on the underlying film 101. The semiconductor layer 102 is formed of polycrystalline silicon (poly-Si). Since poly-Si has high mobility, peripheral circuits such as a scanning line drive circuit can be formed simultaneously. The semiconductor layer 102 is not limited to one formed of polycrystalline silicon. For example, an oxide semiconductor formed of amorphous silicon (a-Si), indium gallium zinc oxide (IGZO), and the like may be used as the semiconductor layer 102. In addition, semiconductor layers SC1 and SC2 (see FIG. 6) of an inspection circuit 40 in the terminal region 30 to be described below are also simultaneously formed using the semiconductor layer 102.

A gate insulating film 103 is formed to cover the semiconductor layer 102. The gate insulating film 103 is, for example, an SiO film formed by CVD using tetraethoxysilane (TEOS) as a raw material. A gate electrode 104 is formed on the gate insulating film 103. The gate electrode 104 is formed of MoW or the like, for example, and is formed simultaneously with the scanning lines 11 (see FIG. 1) described above. In addition, a part of a terminal wiring (a signal terminal 31 and an inspection terminal 32 to be described below) in the terminal region 30 is made of the same material as the gate electrode 104 and formed simultaneously with the gate electrode 104. In addition, similarly to the gate electrode 104, a first wiring 41 of the inspection circuit 40 in the terminal region 30 to be described below is formed of the same material and in the same process as the scanning line 11. A metal layer formed of the same material and in the same process as the scanning line 11 is used as a gate layer.

After the gate electrode 104 is patterned, ion implantation of phosphorus (P), boron (B), or the like is performed to impart conductivity to the semiconductor layer 102 other than a portion below the gate electrode 104. A portion of the semiconductor layer 102 immediately below the gate electrode 104 serves as a channel portion, and the other portions serve as a drain region 1021 or a source region 1022.

Thereafter, an interlayer insulating film 105 is formed. The interlayer insulating film 105 is formed of SiO, SiN, or a laminated film of SiO and SiN. Through-holes 120 and 121 are formed in the interlayer insulating film 105 and the gate insulating film 103, thereby enabling a drain electrode 106 and the drain region 1021 to be connected to each other and a source electrode 107 and the source region 1022 to be connected to each other. The drain electrode 106, the source electrode 107, and the video signal lines 12 (not illustrated in FIG. 2) are simultaneously formed in the embodiment. In addition, a part of the terminal wiring such as a third line (see FIG. 6) to be described below in the terminal region 30 is also formed simultaneously with the drain electrode 106 and the like. A metal layer formed of the same material and in the same process as the video signal line 12 is used as a drain layer. As the drain electrode 106 and the source electrode 107, for example, a member obtained by sandwiching aluminum (Al) or an aluminum alloy between titanium (Ti), or a member obtained by sandwiching aluminum between MoW or the like is used.

An organic passivation film 108 is formed of a transparent resin such as acryl to cover the drain electrode 106 and the source electrode 107. The organic passivation film 108 is formed to have a thickness of 2 μm to 4 μm. As a result, the organic passivation film 108 has a function of a flattening film. A through-hole 130 is formed in the organic passivation film 108, thereby enabling the source electrode 107 and a pixel electrode 111 which will be described below to be connected to each other.

A common electrode 109 is formed of a transparent oxide conductive film such as indium tin oxide (ITO) on the organic passivation film 108. The common electrode 109 is formed in common for every pixel. A capacitance insulating film 110 is formed of SiN to cover the common electrode 109. The pixel electrode 111 is formed of a transparent oxide conductive film such as ITO on the capacitance insulating film 110. ITO in the common electrode 109 or the pixel electrode 111 forms the terminal wiring or a part of a terminal in the terminal region 30.

An oriented film 112 is formed to cover the pixel electrode 111. This is for initially orienting liquid crystal molecules 301. The pixel electrode 111 is formed in a stripe shape or a comb-teeth shape. When a signal voltage is applied to the pixel electrode 111, electric field lines as represented by arrows in FIG. 2 are generated between the pixel electrode and the common electrode 109 formed in a planar shape in the lower layer thereof, and the amount of light transmitted through a liquid crystal layer 300 is controlled by rotating the liquid crystal molecules 301.

As illustrated in FIG. 2, the facing substrate 200 is disposed above the liquid crystal layer 300. The facing substrate 200 is generally formed of glass, but in a case where a flexible display device is desired, the facing substrate 200 is formed of a resin such as polyimide. A color filter 201 and a black matrix 202 are formed below the facing substrate 200. On a lower side of the color filter 201 and the black matrix 202, an overcoat film 203 is formed to cover the color filter 201 and the black matrix 202. A columnar spacer 210 is formed under the overcoat film 203. The columnar spacer 210 maintains spacing between the TFT substrate 100 and the facing substrate 200 constant. An oriented film 204 is formed to cover a lower side of the overcoat film 203.

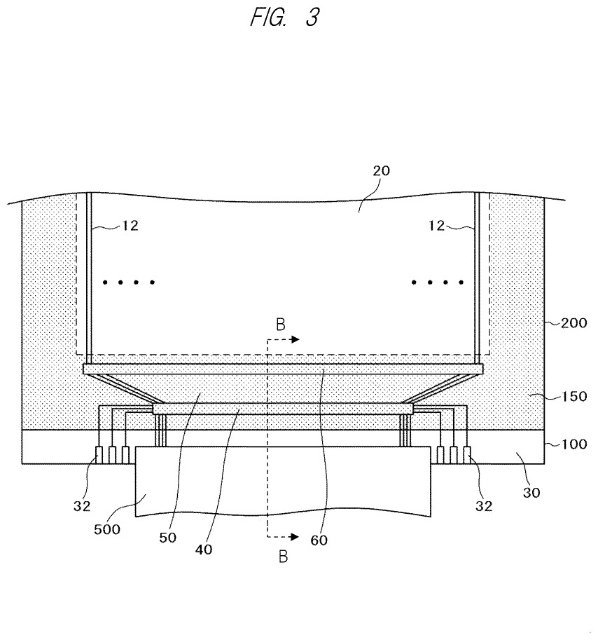

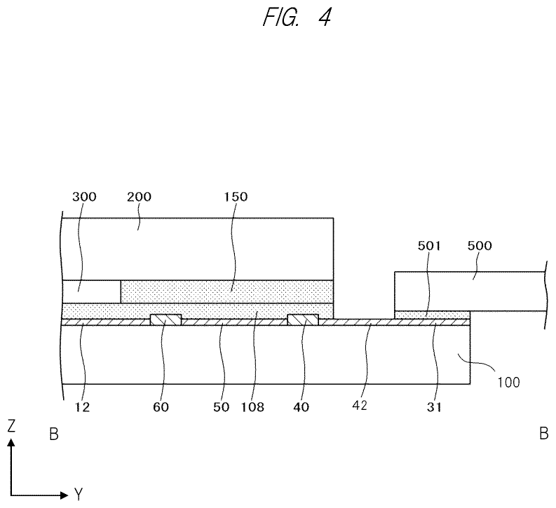

FIG. 3 is an enlarged plan view of the vicinity of the terminal region 30. As illustrated in FIG. 3, perimeter portions of the TFT substrate 100 and the facing substrate 200 are bonded to each other by the sealing material 150. The display region 20 is formed on an inner side surrounded by the sealing material 150. In the terminal region 30, the signal terminal 31 (see FIG. 4 and the like) for connection with the flexible wiring substrate 500 and the inspection terminal 32 for inspection of the display region 20 are formed.

In the display region 20, the video signal lines 12 extend in the Y direction. A very large number of video signal lines 12 are provided. Therefore, a selection circuit 60 is provided in order to reduce the number of wirings in the terminal region 30. The selection circuit 60 is a switching circuit formed of a TFT. For example, the selection circuit 60 is configured to select one type of pixels from red pixels, green pixels, and blue pixels in one frame and sequentially transmit signals, thereby enabling the number of wirings to be reduced to ⅓.

The wirings from the selection circuit 60 are connected to the inspection circuit 40 via an oblique wiring region 50. The inspection circuit 40 is also a switching circuit including many TFTs. The inspection circuit 40 performs switching to enable a signal from the signal terminal 31 or the inspection terminal 32 to be connected to each wiring in the oblique wiring region 50. An inspection process is performed using the inspection terminal 32 before the flexible wiring substrate 500 is connected.

In the embodiment, as illustrated in FIG. 3, the inspection circuit 40 is covered with the facing substrate 200. Hence, the inspection circuit 40 having many TFTs is protected by the facing substrate 200 and the sealing material 150. The oblique wiring region 50 extends to the terminal region 30 via the inspection circuit 40 and is connected to the signal terminals 31 (see FIG. 4 and the like) formed in the terminal region 30. The flexible wiring substrate 500 is connected to the signal terminals 31. In FIG. 3, the driver IC is not mounted on the terminal region 30, but is mounted on the flexible wiring substrate 500.

A case where the driver IC is mounted on the terminal region 30 of the TFT substrate 100 is referred to as Chip on Glass (COG), and a case where the driver IC is mounted on the flexible wiring substrate 500 is referred to as Chip on Film (COF). Video signals supplied to respective video signal lines 12 are arranged by the driver IC. That is, the video signals supplied in serial from the outside are converted into signals in parallel by the driver IC, and the driver IC supplies the converted video signals to the display region 20 of the liquid crystal display device 1. Hence, in the case of the COF, like the liquid crystal display device 1 of the embodiment, the number of terminals is greatly increased as compared with the case of the COG. For example, the number of terminals is about 300 in the case of the COG, but the number of terminals is about 1,500 to 1,800, which is five to six times the number of about 300 in the case of the COF.

FIG. 4 is a diagram illustrating a cross section along B-B in FIG. 3. As illustrated in FIG. 4, the perimeter portions of the TFT substrate 100 and the facing substrate 200 are bonded to each other by the sealing material 150. Liquid crystal is sealed in the liquid crystal layer 300 surrounded by the TFT substrate 100, the facing substrate 200, and the sealing material 150. On the TFT substrate 100 side, the video signal lines 12, the selection circuit 60, the oblique wiring region 50, the inspection circuit 40, the second wiring 42, and the signal terminals 31 are formed.

In FIG. 4, the video signal lines 12, the selection circuit 60, the oblique wiring region 50, the inspection circuit 40, and a part of the second wiring 42 are covered with the organic passivation film 108, and are further protected by the sealing material 150 and the facing substrate 200 provided on the sealing material 150. Since the inspection circuit 40 is provided under the sealing material 150 and the like to be protected as described above, reliability of the inspection circuit 40 can be ensured. On the TFT substrate 100, the second wiring 42 extends from the inspection circuit 40 toward the signal terminal 31. In the Z direction, the signal terminals 31 are connected to the flexible wiring substrate 500 via an anisotropic conductive film (ACF) 501. As illustrated in FIG. 2, the second wiring 42 may be covered with the capacitance insulating film 110 made of SiN and the organic passivation film 108, but may be exposed.

FIG. 5 is a diagram illustrating an equivalent circuit corresponding to FIG. 3. FIG. 5 illustrates a part of the equivalent circuit for convenience of description. As illustrated in FIG. 5, video signal lines 12 extend in the Y direction from the selection circuit 60 on the display region 20 side. The selection circuit 60 includes many switches 61 made of the TFTs. As described above, the selection circuit 60 is configured to transmit a signal three times in one frame, so that the number of wirings on the terminal region 30 side of the selection circuit 60 can be reduced to ⅓.

The oblique wiring region 50 connects the selection circuit 60 and the inspection circuit 40. For example, by reducing the number of wirings of the selection circuit 60 on the terminal region 30 side to ⅓, pitches of the signal terminals 31 can be decreased more than wiring pitches in the selection circuit 60. Hence, oblique wirings 51 are formed between the selection circuit 60 and the inspection circuit 40. The wiring pitches are more decreased in a portion of the oblique wirings 51 than in the case where the wiring extends in the Y direction. Therefore, it is difficult to secure wiring spacing in the portion of the oblique wirings 51. Therefore, the wiring becomes a multilayer wiring in the portion of the oblique wirings 51. That is, in the oblique wiring region 50, through-holes 90 and 91 are formed in every other oblique wire 51, and the wirings are transferred from the drain layer to the gate layer, for example.

The inspection circuit 40 is a circuit that inspects a disconnection or a short circuit of the large number of wirings. In the oblique wiring region 50, a plurality of oblique wirings 51 extending from the individual switches 61 in the selection circuit 60 are arranged. In the inspection circuit 40, an inspection switch 40a is provided for each of the oblique wirings 51. The inspection switch 40a is a switch that performs switching to connect the oblique wire 51 to either the first wiring 41 or the second wiring 42. The first wirings 41 are connected to the inspection terminals 32 used at the time of inspection performed before the flexible wiring substrate 500 is connected. The second wirings 42 are connected to the signal terminals 31 to which the flexible wiring substrate 500 is connected.

As illustrated in FIG. 3, a plurality of inspection terminals 32 is provided on the left and right of a signal terminal 31 group. The first wirings 41 connected to the inspection terminals 32 extend in the X direction and are arranged in the Y direction in the inspection circuit 40. The oblique wire 51 in the oblique wiring region 50 is connected to any one of the first wirings 41 via the inspection switch 40a. When the inspection is performed, inputs to the inspection terminals 32 are sequentially switched, and thereby inspection of the wiring of the oblique wirings 51 and a disconnection of the video signal lines 12 destined thereto is performed.

The configuration illustrated in FIGS. 3 to 5 enables the inspection of a disconnection, a short circuit, or the like of the wirings extending from the inspection circuit 40 toward the display region 20 in the inspection process at the time of manufacturing the liquid crystal display device 1.

### Structure of Inspection Circuit

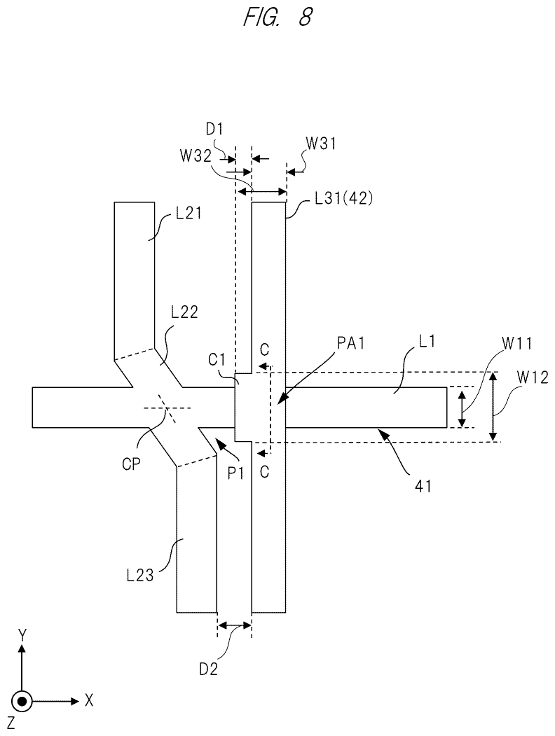

Next, a structure of the inspection circuit 40 will be described with reference to FIGS. 6 to 8. FIG. 6 is a schematic plan view illustrating a part of a structure example of the inspection circuit 40. FIG. 7 is a diagram illustrating a cross section along C-C in FIG. 6. FIG. 8 is a diagram for illustrating a structure around a connection portion L22 of the first wiring 41 and the second wiring 42 included in the inspection circuit 40.

As illustrated in FIG. 6, the inspection circuit 40 includes the first wiring 41 and the second wirings 42. The first wiring 41 includes a first line L1 extending in the first direction, that is, the X direction in the embodiment, and a second line L2 obliquely intersecting the first line L1. The second wiring 42 is provided at an upper layer above the first wiring 41 and includes third lines L31, L32, L33, and L34 which are orthogonal to the first line L1 extending in the X direction in plan view. Further, the second wiring 42 includes third lines L35 and L36. The third line L35 (51) is laid side by side with the third line L34 in the X direction and is laid to extend in the Y direction above the first line L1 illustrated in FIG. 6. Hence, the third line L35 and the third line L34 closest to the connection portion L22 are laid across the second line L2, and the third line L35 does not intersect the first line L1 in plan view. The third line L36 is laid side by side with the third line L31 in the X direction and is laid to extend in the Y direction below the first line L1 illustrated in FIG. 6. Hence, the third line L36 and the third line L31 closest to the connection portion L22 are laid across the second line L2, and the third line L36 does not intersect the first line L1 in plan view.

The inspection circuit 40 is a transistor including the semiconductor layers SC1 and SC2. The semiconductor layer SC1 is disposed as a lower layer below the third line L34 and the third line L35. The semiconductor layer SC1 overlaps a part of the third line L34, a part of the third line L35, and a part of the second line L2 in plan view. In plan view, a contact hole 71 is provided in the part of the third line L34 which overlaps the semiconductor layer SC1. In plan view, a contact hole 72 is provided in the part of the third line L35 which overlaps the semiconductor layer SC1.

In addition, a semiconductor layer SC2 is disposed in a lower layer below the third line L31 and the third line L36. The semiconductor layer SC2 overlaps a part of the third line L31, a part of the third line L36, and a part of the second line L2 in plan view. In plan view, a contact hole 81 is provided in the part of the third line L31 which overlaps the semiconductor layer SC2. In plan view, a contact hole 82 is provided in the part of the third line L36 which overlaps the semiconductor layer SC2.

Hence, in FIG. 6, in the inspection circuit 40, the third line L34 is connected to a source layer of the semiconductor layer SC1 via the contact hole 71, the third line L35 is connected to a drain layer of the semiconductor layer SC1 via the contact hole 72, the third line L36 is connected to a source layer of the semiconductor layer SC2 via the contact hole 82, and the third line L31 is connected to a drain layer of the semiconductor layer SC2 via the contact hole 81. The second line L2 is a gate layer of both the semiconductor layers SC1 and SC2. The first line L1 is connected to the inspection terminal 32 that performs display inspection of the display region 20.

The second line L2 has a connection portion L22 that obliquely intersects and is connected to the first line L1, a first portion L21 that is disposed side by side with the third line L34 from one end of the connection portion L22, and a second portion L23 that is disposed side by side with the third line L31 from another end of the connection portion L22. A longitudinal direction of the connection portion L22 intersects, at a predetermined angle, a direction in which the first line L1 extends. In the embodiment, in plan view, the direction in which the first portion L21 and the second portion L23 of the second line L2 extend is parallel to the direction in which the third lines L34 and L31 extend. An intersection point between a center line of the first line L1 and a center line of the connection portion L22 of the second line L2 is represented by an intersection point CP.

In the embodiment, four of the third lines L31, L32, L33, and L34 among the plurality of provided third lines are illustrated as an example, and illustration or the like of other third lines and the like which are unnecessary for the description is omitted. The third lines L31, L32, L33, and L34 are arranged in parallel in the X direction to extend in the Y direction. The third lines L31, L32, and L33 are provided on the right side of the second line L2. The third line L31 is disposed closest to the second line L2, and then the third lines L32 and L33 are disposed in this order. The third line L34 is disposed on the left side of the second line L2 and closest to the second line L2. Although not illustrated, the third lines which do not have a wide portion to be described below are further arranged on the left side of the third line L34. The plurality of third lines (not illustrated) having the same configuration as the third lines L32 and L33 are arranged on the left side of the third line L34, for example.

The two third lines L31 and L34 arranged across the intersection point CP have wide portions C1 and C2, respectively. More specifically, the third line L31 has, at a portion intersecting the first line L1, a wide portion C1 having a width which increases toward the connection portion L22 side, in plan view. For example, in a case where a width of a portion of the third line L31 other than the wide portion C1 in the X direction is represented by a width W31, the width of the wide portion C1 is a width W32 (>W31). In other words, the wide portion C1 projects toward the intersection point CP by a distance D1. In addition, in the Y direction, in a case where a width of the portion other than the wide portion C1 is represented by W11, a width of the wide portion C1 is represented a width W12 (>W11). As described above, the wide portion C1 has the width wider than the width of the other portions of the third line L31 in the X direction and the Y direction. The wide portion C2 of the third line L34 has the same configuration as the wide portion C1 except that the wide portion C2 is disposed to face the wide portion C1, and thus the detailed description thereof is omitted. The two wide portions C1 and C2 are disposed to face each other across the connection portion L22.

Only the third line L31 closest to the connection portion L22 has the wide portion C1, and only the third line L34 closest to the connection portion L22 has the wide portion C2. That is, the third lines L32 and L33 and the like which are not adjacent to the connection portion L22 do not have a wide portion at a portion intersecting the first line L1.

As illustrated in FIG. 8, the first wiring 41 has a configuration in which the first line L1 and the second line L2 are connected by a connection portion L22. Therefore, in the first wiring 41, a triangular recess P1 is formed in a portion where the connection portion L22 of the second line L2 and the first line L1 intersect each other in plan view. The recess P1 is provided closer to the intersection point CP than a distance D2 between the second portion L23 of the second line L2 and the third line L31. In other words, the recess P1 is disposed on a side farther away from an intersection portion PA1 than the distance D2 between the second portion L23 of the second line L2 and the third line L31. The intersection portion PA1 is a portion where the first line L1 intersects the third line L31 in plan view. Hence, a portion where the first line L1 including the intersection point CP intersects the connection portion L22 is disposed apart from the intersection portion PA1 by the distance D2 or longer. Therefore, it is possible to reduce an effect of forming the connection portion L22 on the intersection portion PA1. That is, in the first wiring 41, it is possible to reduce the occurrence of variation in the shape of the first line L1.

As illustrated in FIG. 7, the shape of the first line L1 does not vary. In the shape of the first line L1, for example, a side surface SI1 and a side surface SI2 are symmetrical with respect to a center line VL. In addition, both the side surface SI1 and the side surface SI2 have a low angle with respect to a bottom surface B1. That is, the shape of the first line L1 is a low-taper shape that gradually widens downward. Therefore, the gate insulating film 103 formed on the first line L1 is also easily formed without variation. Further, the third line L31 formed on the gate insulating film 103 is also easily formed without variation. Hence, the liquid crystal display device 1 can prevent the disconnection from occurring in the third line L31.

In addition, for example, in a case where the shape of the first line L1 varies for some reasons in the manufacturing process, variations in the shape of the gate insulating film 103 formed on the first line L1 may also occur. Even in such a case, the third line L31 has the wide portion C1. That is, for example, in a case where the third line L31 is formed from the lower side to the upper side in FIG. 8 in the Y direction, the width of the third line L31 becomes wide in front and behind the intersection portion PA1, that is, from a short distance in front of the first line L1 to a short distance behind the first line L1. In the embodiment, the width of the third line L31 changes from the width W31 to the width W32 (>W31). Since the third line L31 has the wide portion C1 as described above, the third line L31 can be improved against the likelihood of a disconnection. Hence, the liquid crystal display device 1 can prevent the disconnection from occurring in the third line L31.

### Structure of and Comparison With Inspection Circuit of Comparative Example

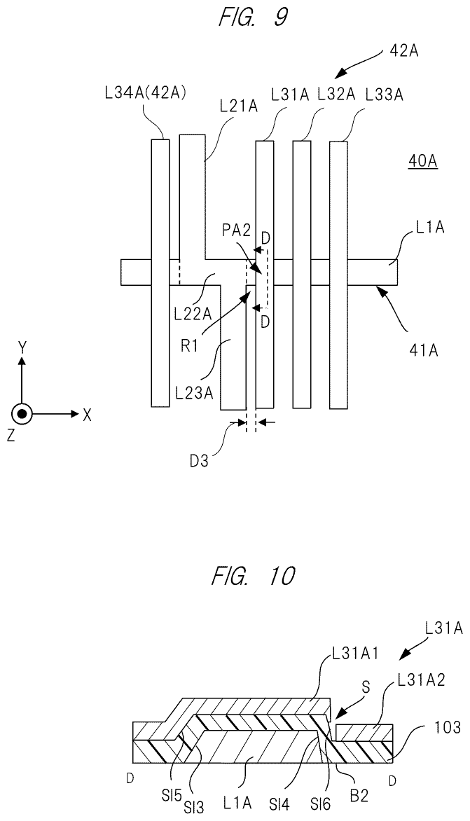

Next, a structure example of an inspection circuit in a comparative example will be described with reference to FIGS. 9 and 10. FIG. 9 is a schematic plan view illustrating the structure example of the inspection circuit according to the comparative example. FIG. 10 is a diagram illustrating a cross section along D-D in FIG. 9. In FIG. 9, illustration of the semiconductor layers SC1 and SC2 and the plurality of third lines which are unnecessary for the description is omitted.

### Structure of Inspection Circuit of Comparative Example

As illustrated in FIG. 9, an inspection circuit 40A includes a first wiring 41A and a second wiring 42A. The first wiring 41A includes a first line L1A, a first portion L21A, and a second portion L23A. The first line L1A extends in the X direction. One end of the first portion L21A is connected to the first line L1A. The first portion L21A extends upward in the Y direction from a position connected to the first line L1A in FIG. 9. The second portion L23A is disposed to be shifted from the first portion L21A by a predetermined distance in the X direction. One end of the second portion L23A is connected to the first line LA. The second portion L23A extends downward in the Y direction from the position connected to the first line L1A in FIG. 9. In the first line L1A, a portion where the first portion L21A and the second portion L23A are connected thereto and a portion therebetween are defined as a connection portion L22A.

The second wiring 42A includes third lines L31A, L32A, L33A, and L34A. The third lines L31A, L32A, L33A, and L34A are arranged in parallel in the X direction to extend in the Y direction. The third lines L31A, L32A, and L33A are provided on the right side of the second portion L23A. The third line L31A is disposed closest to the second portion L23A, and then the third lines L32A and L33A are disposed in this order. The third line L34A is disposed on the left side of the first portion L21A.

### Comparison With Comparative Example

As illustrated in a region R1, the second portion L23A and the third line L31A are arranged to be separated by a distance D3 in the X direction. However, the inspection circuit 40A illustrated in FIG. 9 does not have the recess P1 provided in the inspection circuit 40 of the embodiment illustrated in FIG. 8. Therefore, as compared with the case of FIG. 8, the connection portion L22A and an intersection portion PA2 are arranged close to each other. The intersection portion PA2 is a portion where the first line L1A intersects the third line L31A in plan view. For example, in a case where the distance D3 and the distance D2 in FIG. 8 are the same distance, the connection portion L22A and the intersection portion PA2 are closer in the comparative example than in the embodiment by the recess P1. Therefore, at the time of forming the third line L31A, variations in the shape of the formed third line L31A may occur in the intersection portion PA2 due to an effect of the connection portion L22A.

For example, as illustrated in FIG. 10, variations in the shape of the third line L31A may occur. A side surface SI3 has a low angle with respect to a bottom surface B2, but a side surface SI4 has a high angle with respect to the bottom surface B2. Therefore, variations in the shape of the gate insulating film 103 formed on the first line L1A also occur. For example, in the gate insulating film 103, a side surface SI5 formed above the side surface SI3 has a low angle with respect to the bottom surface B2, but a side surface SI6 formed above the side surface SI4 has a high angle with respect to the bottom surface B2. That is, the gate insulating film 103 has a low-taper shape on the left side in FIG. 10, but the gate insulating film 103 has a high-taper shape on the right side. In a case where the gate insulating film 103 is formed in the high-taper shape, for example, a disconnection may occur in the third line L31A formed on the gate insulating film 103 due to deterioration in attachment of the third line L31A.

For example, when the third line L31A is formed, a gap S is generated in the third line L31A on a high-taper portion of the gate insulating film 103. In this case, the third line L31A is divided into a portion of a third line L31A1 and a portion of a third line L31A2, and a disconnection occurs in the third line L31A. In addition, in a case where variations in the shape of the first line LIA occur for some reasons in the manufacturing process, a disconnection may also occur in the third line L31A.

On the other hand, as illustrated in FIG. 8, in the liquid crystal display device 1 of the embodiment, the connection portion L22 of the second line L2 can be disposed away from the intersection portion PA1 by the shape in which the connection portion L22 intersects the first line L1. Additionally, since the wide portion C1 is provided in the third line L31 closest to the connection portion L22, the third line L31 is improved against the likelihood of the disconnection. Therefore, the liquid crystal display device 1 can prevent the disconnection from occurring in the third line L31 in the inspection circuit 40. The third line L34 is similar to the third line L31. In addition, the wide portion C1 is provided only in the third line L31 closest to the connection portion L22, and thereby the second wiring 42 does not need to increase interline pitches between the third lines L31, L32, and L33 and can prevent a region of the second wiring 42 in the X direction from being widened.

### Modification Example of Inspection Circuit

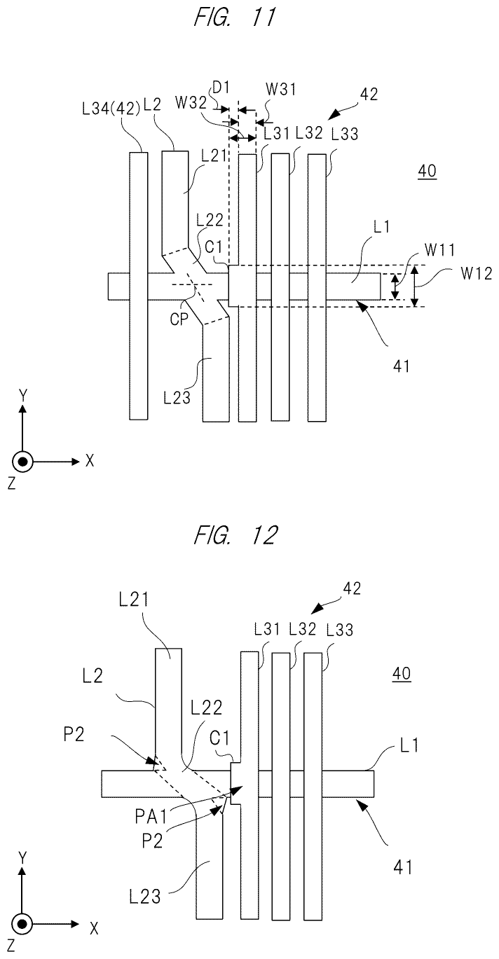

FIG. 11 is a schematic plan view illustrating a modification example of the inspection circuit 40. In FIG. 11, illustration of the semiconductor layers SC1 and SC2 and the plurality of third lines which is unnecessary for the description is omitted. As illustrated in FIG. 11, in the inspection circuit 40, the wide portion C1 is provided in the third line L31, but the wide portion C1 is not provided in the third line L34. Other configurations are the same as those illustrated in FIG. 8. As described above, in the liquid crystal display device 1, the wide portion may be provided only in one third line facing the connection portion L22, in the inspection circuit 40.

### Modification Example of First Wiring

FIG. 12 is a diagram illustrating a modification example of the first wiring 41. In FIG. 12, illustration of the semiconductor layers SC1 and SC2 and the plurality of third lines which is for the description is omitted. As illustrated in FIG. 12, in the first wiring 41, the connection portion L22 connecting the first line L1 and the second line L2 is not definitely provided as compared with the case illustrated in FIG. 8 and the like. That is, in the modification example, a coupling region P2 in which the first line L1 is coupled to the connection portion L22 illustrated in FIG. 8 and the like is provided. The coupling region P2 is, for example, a region including the recess P1, and couples the first line L1 to the connection portion L22. Even if variations in the shape of the first line L1 occur in the intersection portion PA1 due to the first wiring 41 formed as described above, the wide portion C1 of the third line L31 enables the liquid crystal display device 1 to prevent a disconnection of the third line L31 from occurring.

The present invention is applicable to a display device and an array substrate.

What is claimed is:

1. A display device comprising:
a display unit; and
an inspection unit that performs display inspection of the display unit, the inspection unit including a first wiring which has a first line extending in a first direction and a second line obliquely intersecting the first line, and a second wiring which is provided at an upper layer above the first wiring and has third lines orthogonal to the first line extending in the first direction in plan view,
wherein the second line has a connection portion that obliquely intersects and is connected to the first line, a first portion that is disposed side by side with the third lines from one end of the connection portion, and a second portion that is disposed side by side with the third lines from another end of the connection portion in an opposite direction to the first portion,
wherein the third lines have respective wide portions having a width which increases toward the connection portion, and
wherein the wide portion is located at an intersection portion where the third lines and the first line intersect each other in plan view.

2. The display device according to claim 1,
wherein, in plan view, a direction in which the first portion of the second line extends and a direction in which the second portion of the second line extends are both parallel to a direction in which the third lines extend.

3. The display device according to claim 2,
wherein the second wiring has the two third lines across the connection portion,
wherein the two third lines have the respective wide portions, and
wherein the two wide portions are disposed to face each other across the connection portion.

4. The display device according to claim 2,
wherein the second wiring has a plurality of the third lines,
wherein the plurality of third lines is arranged side by side in the first direction, and
wherein only the third line closest to the connection portion has the wide portion.

5. The display device according to claim 4,
wherein the first line is connected to an inspection terminal that performs display inspection of the display unit.

6. The display device according to claim 4, further comprising:
a first substrate having a first rectangular shape in plan vin plan view; and
a second substrate having a second rectangular shape with one of four sides of the first rectangular shape projecting in plan view,
wherein the first substrate and the second substrate are provided to overlap each other,
wherein a perimeter portion of the first substrate is bonded to the second substrate via a sealing material,
wherein the display unit is formed in a region surrounded by the sealing material, and
wherein the inspection unit is provided below the sealing material on the second substrate.

7. An array substrate comprising
an inspection unit that performs display inspection, the inspection unit including a first wiring which has a first line extending in a first direction and a second line obliquely intersecting the first line, and a second wiring which is provided at an upper layer above the first wiring and has third lines orthogonal to the first line extending in the first direction in plan view,
wherein the second line has a connection portion that obliquely intersects the first line, a first portion that is disposed side by side with the third lines from one end of the connection portion, and a second portion that is disposed side by side with the third lines from another end of the connection portion in an opposite direction to the first portion,
wherein the third lines have respective wide portions having a width which increases toward the connection portion, and
wherein the wide portion is located at an intersection portion where the third lines and the first line intersect each other in plan view.
